(19) United States
(12) Patent Application Publication
(10) Pub. No.: US 2018/0266029 A1
(43) Pub. Date: Sep. 20, 2018

(54) Matrix for Letters or Patterns on Fabric

(71) Applicant: Yong Chong KIM, Los Angeles, CA (US)

(72) Inventor: Yong Chong KIM, Los Angeles, CA (US)

(21) Appl. No.: 15/921,575

(22) Filed: Mar. 14, 2018

Related U.S. Application Data
(60) Provisional application No. 62/472,036, filed on Mar. 16, 2017.

(51) Int. Cl. D06C 23/00

(52) U.S. Cl. CPC D06C 23/00; B44F 1/08

(57) ABSTRACT

A matrix for letters and patterns on fabric is provided. The matrix comprises holes, edge portions, and decorating portions. The holes are disposed in a matrix form, and each of them is provided through the fabric. Each of the edge portions is installed at one of the holes. Each of the decorating portions is detachably attached to one of the edge portions. The holes and the edge portions may be combined so as to form engaging portions. Another matrix for letters and patterns on fabric may be provided, and the matrix comprises holes, each of which being provided through the fabric, disposed in a matrix form. Each of the holes comprises a vertical slit portion, a top end portion of warps, and a bottom end portion of warps. The matrix may comprise two side dot portions disposed on both sides of each of the vertical slit portions.

### RELATED APPLICATION

This application is a Non-provisional application of Provisional Application Ser. No. 62/472,036 for “MATRIX FOR LETTERS OR PATTERNS ON FABRIC” filed on Mar. 16, 2017.

### BACKGROUND OF THE INVENTION

The present invention relates to a matrix for letters and patterns on fabric.

Sometimes, fabric or cloth needs to be decorated with letters or patterns.

Accordingly, a need for a matrix for letters and patterns on fabric has been present for a long time considering the expansive demands in the everyday life. This invention is directed to solve these problems and satisfy the long-felt need.

### SUMMARY OF THE INVENTION

The present invention contrives to solve the disadvantages of the prior art.

An aspect of the invention provides a matrix for letters and patterns on fabric.

The matrix comprises a plurality of holes, a plurality of edge portions, and one or more decorating portions.

The plurality of holes are disposed in a matrix form, and each of them is provided through the fabric.

Each of the plurality of edge portions is installed at a corresponding one of the plurality of holes.

Each of the one or more decorating portions is detachably attached to one of the plurality of edge portions.

The matrix form for the plurality of holes may include a rectangular lattice structure.

Each of the plurality of edge portions may comprise an eyelet, which is made of metal.

Each of the one or more decorating portions may comprise a string configured to be queued through some of the plurality of edge portions, so as to make letters or patterns.

Another aspect of the invention provides a matrix for letters and patterns on fabric, comprising a plurality of anchoring portions and one or more decorating portions.

Each of the plurality of anchoring portions, which are disposed in a matrix form, is provided on the fabric.

Each of the one or more decorating portions is detachably attached to one of the plurality of anchoring portions. The matrix form for the plurality of anchoring portions may include a rectangular lattice structure.

Each of the one or more decorating portions may comprise an engaging portion configured to be attached detachably to a corresponding anchoring portion, so as to attach the decorating portion to the corresponding anchoring portion.

Each of the plurality of anchoring portions may comprise a thumbtack protruding upward or a thumbtack receding inward.

Each of the plurality of anchoring portions may further comprise an edge portion, which is configured to be fixed to the fabric.

Each of the plurality of anchoring portions may comprise a dumbbell-shaped hook having a top disk, a bottom disk, and a connecting cylinder connecting the top and bottom disks.

The bottom disk may be configured to be fixed to a rear side of the fabric and the connecting cylinder is disposed through the fabric

Each of the plurality of anchoring portions may comprise an open hook having a hook portion and an engaging portion.

Still another aspect of the invention provides a matrix for letters and patterns on fabric, and the matrix comprises a plurality of holes, each of which being provided through the fabric, disposed in a matrix form.

Each of the plurality of holes comprises a vertical slit portion, a top end portion of warps forming the top edge of the vertical slit portion, and a bottom end portion of warps forming the bottom edge of the vertical slit portion. The matrix form for the plurality of holes may include a rectangular lattice structure.

The matrix may further comprise two side dot portions disposed on both sides of each of the vertical slit portions.

The two side dot portions has a color different from colors of the fabric, or the top and bottom end portions of warps.

The advantages of the present invention are: (1) the matrix for letters and patterns on fabric according to the invention provides a simple structure for performing the purposes; and (2) the matrix for letters and patterns on fabric according to the invention provides a sturdy structure using a minimal number of components in order to achieve the above goals.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a plan view showing a matrix for letters and patterns on fabric according to an embodiment of the invention;

FIG. 2 is a plan view showing a matrix for letters and patterns on fabric according to another embodiment of the invention;

FIG. 3 is a plan view showing a matrix for letters and patterns on fabric according to still another embodiment of the invention;

FIG. 4 is a plan view showing a matrix for letters and patterns on fabric according to still another embodiment of the invention;

FIG. 5 is a side view of one of the thumbtack structures in FIG. 4;

FIG. 6 is a plan view showing a matrix for letters and patterns on fabric according to still another embodiment of the invention;

FIG. 7 is a side view of one of the thumbtack structures in FIG. 6;

FIG. 8 is a side view showing a thumbtack structure in a matrix for letters and patterns on fabric according to still another embodiment of the invention;

FIG. 9 is a side view showing a thumbtack structure in a matrix for letters and patterns on fabric according to still another embodiment of the invention;

FIG. 10 is a plan view showing a matrix for letters and patterns on fabric along with decoration attachments according to still another embodiment of the invention;

FIG. 11 is a side cross-sectional view showing engagement between a protruding thumbtack and a decorating portion according to an embodiment of the invention;

FIG. 12 is a top plan view showing a matrix of vertical slits with top and bottom end portions and side dot portions according to another embodiment of the invention;

FIG. 13 is a top plan view showing holes according to an embodiments of the invention; and

FIG. 14 is another top plan view showing holes with vertical slit portions and top and bottom end portions according to another embodiment of the invention.

### DETAILED DESCRIPTION EMBODIMENTS OF THE INVENTION

Referring to the figures, the embodiments of the invention are described in detail.

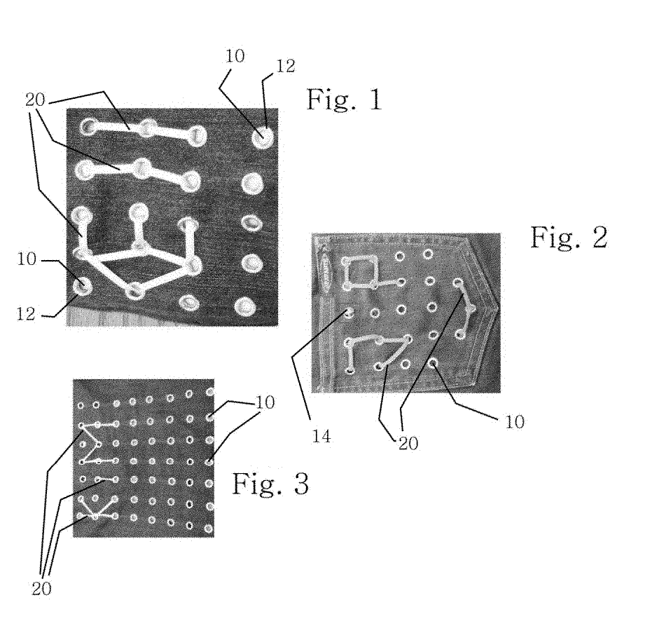

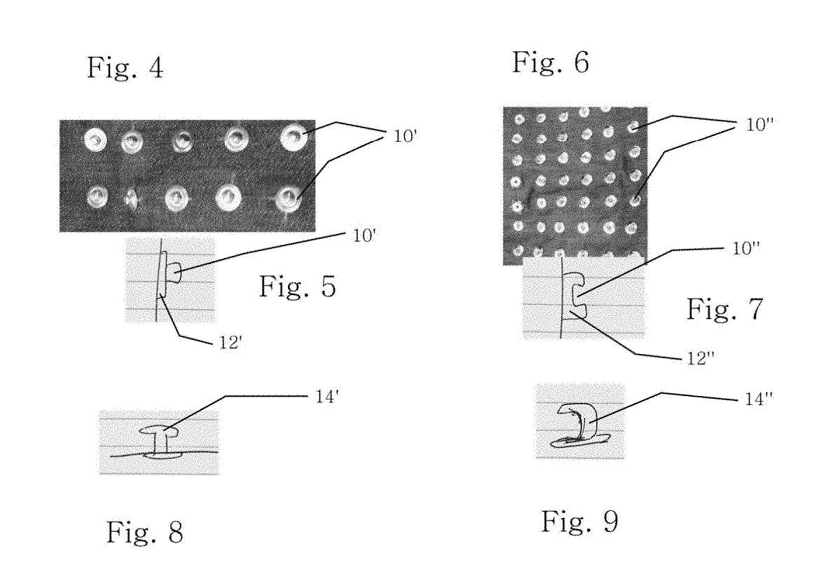

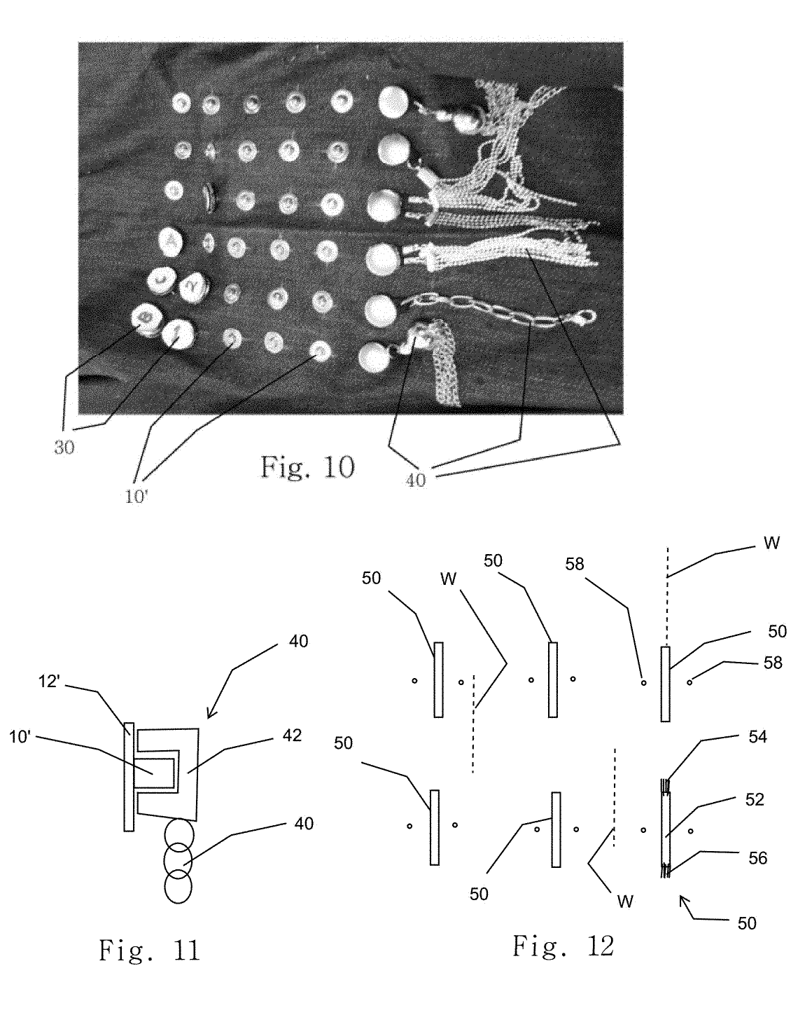

FIGS. 1 to 3 show a matrix of holes and letters and patterns according to embodiments of the invention, FIGS. 4 and 5 show a matrix of protruding thumbtacks according to another embodiments of the invention, FIGS. 6 and 7 show a matrix of receding thumbtacks according to still another embodiments of the invention, FIGS. 8 and 9 show another types of hooks according to still another embodiments of the invention, and FIG. 10 shows decorating attachments hooked on a matrix of protruding thumbtacks according to still another embodiments of the invention.

FIG. 1 shows a matrix for letters and patterns on fabric according to an embodiment of the invention. The holes (10) are provided through the fabric (blue jean like base material in the figure). Furthermore, each hole (10) is enclosed by an edge portion (12), which may be made of metal as illustrated. However, the edge portion (12) can be made of any material as long as it can maintain the hole (10) within in the middle of the fabric. Now, the holes (10) can be made to knit letters or patterns with strings (20). Ready-made letters or patterns (not shown) in such style can be made to apply to the fabric.

FIG. 2 shows a matrix for letters and patterns on fabric according to another embodiment of the invention. A hole (10) may be installed with a hook (14) shown in the red box in the figure, which can be used to anchor another structures instead of the hole (10).

FIG. 3 shows a large matrix for letters and patterns on fabric according to still another embodiment of the invention, in which the holes (10) and the strings (20) knitted along some of the holes (10) can be used to form letters or patterns.

FIGS. 4 and 5 show a matrix for letters and patterns on fabric according to still another embodiment of the invention, in which protruding thumbtacks (10′) are used for the holes (10) in other embodiments to form a matrix. The protruding thumbtacks (10′) can be used to anchor or hold in place other materials to form letters or patterns.

FIGS. 6 and 7 show a matrix for letters and patterns on fabric according to still another embodiment of the invention, in which the receding thumbtacks (10″) are used for the holes (10) in other embodiments to form a matrix. The receding thumbtacks (10″) can be used to anchor or hold in place other materials to form letters or patterns.

FIG. 8 shows a thumbtack structure in a matrix for letters and patterns on fabric according to still another embodiment of the invention, in which another type of hook (14′) can be disposed through the hole (10) as in FIG. 2.

FIG. 9 shows a thumbtack structure in a matrix for letters and patterns on fabric according to still another embodiment of the invention, in which still another type of hook (14″) can be disposed through the hole (10) as in FIG. 2.

Still the hooks are not limited to the types of FIGS. 8A and 9 as discussed briefly in the above.

FIG. 10 shows a matrix for letters and patterns on fabric along with decoration attachments according to still another embodiment of the invention. As discussed in the above, the matrix of holes (10, 10′, 10″) or hooks (14, 14′, 14″) can be used to form letters and patterns or anchor the decoration attachments (30, 40), each of which including a corresponding fasteners for engaging the matrix of holes (10, 10′, 10″) or hooks (14, 14′, 14″) directly.

Using the above matrix of holes (10, 10′, 10″) or hooks (14, 14′, 14″), the fabric or cloth can be decorated with letters, patterns, or decoration attachments as described in the figures.

Furthermore, the matrix may further comprise a lining or line clothes behind the matrix, so as to prevent a wearer's skin from being abraded by the matrix structure.

FIG. 11 shows engagement between a protruding thumbtack and a decorating portion according to an embodiment of the invention.

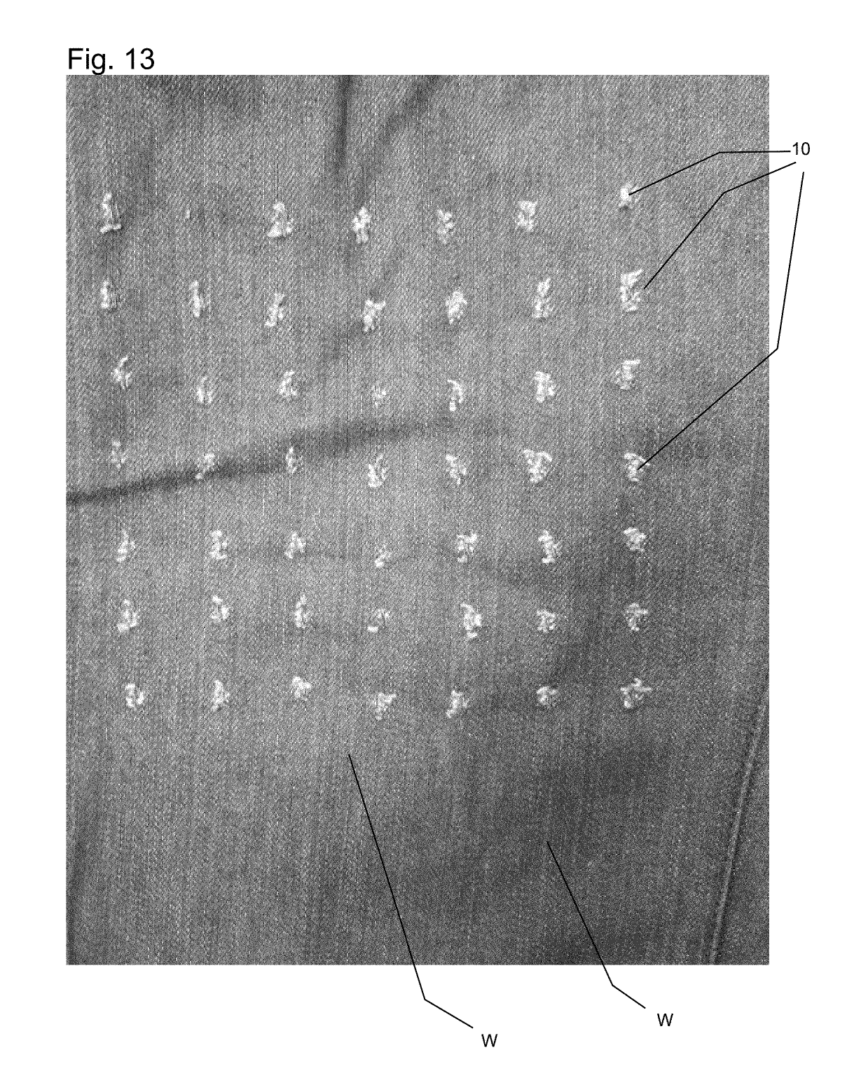

FIG. 12 shows a matrix of vertical slits with top and bottom end portions and side dot portions according to another embodiment of the invention.

An aspect of the invention provides a matrix for letters and patterns on fabric as shown in FIGS. 1-3.

The matrix comprises a plurality of holes (10), a plurality of edge portions (12), and one or more decorating portions (20).

The plurality of holes (10) are disposed in a matrix form, and each of them is provided through the fabric shown on the background as a blue jean fabric.

Each of the plurality of edge portions (12) is installed at a corresponding one of the plurality of holes (10). In principle, each of the plurality of edge portions (12) may have various shapes other than the circle, too, for example, triangle, square, or hexagon.

Each of the one or more decorating portions (20) is detachably attached to or through one of the plurality of edge portions (12).

The matrix form for the plurality of holes (10) may include a rectangular lattice structure. In certain embodiments of the invention, the matrix form may further comprise triangular (partially shown in the lower portion in FIG. 1, which are connected with the white string) or hexagonal (lower half of a hexagonal structure is shown in the lower half of FIG. 1, which are connected with the white string).

Each of the plurality of edge portions (12) may comprise an eyelet, which is made of metal.

Each of the one or more decorating portions (20) may comprise a string configured to be queued through some of the plurality of edge portions (12), so as to make letters or patterns. The string may be tied below the fabric (not shown) or fixed by other conventional fastening devices.

As shown in FIGS. 4-10, another aspect of the invention provides a matrix for letters and patterns on fabric, comprising a plurality of anchoring portions (10′, 10″, 12′, 12″, 14′, 14″) and one or more decorating portions (40) shown in FIG. 10.

Each of the plurality of anchoring portions, which are disposed in a matrix form, is provided on the fabric. As in the previous embodiment, in certain embodiments of the invention, the matrix form may further comprise triangular (partially shown in the lower portion in FIG. 1, which are connected with the white string) or hexagonal (lower half of a hexagonal structure is shown in the lower half of FIG. 1, which are connected with the white string).

Each of the one or more decorating portions (40) may be detachably attached to one of the plurality of anchoring portions as shown in FIG. 10.

Each of the one or more decorating portions (40) may comprise an engaging portion configured to be attached detachably to a corresponding anchoring portion, so as to attach the decorating portion to the corresponding anchoring portion as shown in FIGS. 10 and 11.

Each of the plurality of anchoring portions may comprise a thumbtack protruding upward or a thumbtack receding inward as shown in FIGS. 4-7.

Each of the plurality of anchoring portions may further comprise an edge portion (12′, 12″), which is configured to be fixed to the fabric, as shown in FIGS. 5 and 7.

Each of the plurality of anchoring portions may comprise a dumbbell-shaped hook (14′) having a top disk, a bottom disk, and a connecting cylinder connecting the top and bottom disks as shown in FIG. 8. The horizontal line right above the bottom disk is the fabric. The bottom disk may be configured to be fixed to a rear side of the fabric and the connecting cylinder is disposed through the fabric.

Each of the plurality of anchoring portions may comprise an open hook (14″) having a hook portion and an engaging portion as shown in FIG. 9.

As shown in FIG. 12, still another aspect of the invention provides a matrix for letters and patterns on fabric, and the matrix comprises a plurality of holes (50), each of which being provided through the fabric, disposed in a matrix form.

Each of the plurality of holes (50) comprises a vertical slit portion (52), a top end portion (54) of warps (W) forming the top edge of the vertical slit portion (52), and a bottom end portion (56) of warps (W) forming the bottom edge of the vertical slit portion (52). The matrix form for the plurality of holes (50) may include a rectangular lattice structure. As in the previous embodiments, in certain embodiments of the invention, the matrix form may further comprise triangular (partially shown in the lower portion in FIG. 1, which are connected with the white string) or hexagonal (lower half of a hexagonal structure is shown in the lower half of FIG. 1, which are connected with the white string).

The matrix may further comprise two side dot portions (58) disposed on both sides of each of the vertical slit portions (52). Such dot portions may be obtained by applying a punctuating pressure on the fabric.

The two side dot portions (58) has a color different from colors of the fabric, or the top and bottom end portions of warps (54, 56). Such contrast of colors may produce optical patterns with the other components across the fabric.

FIG. 13 is a top plan view showing holes (10) according to an embodiments of the invention. Each of the holes (10) is bored or provided through the fabric, the blue jean fabric in the illustrated embodiment. As in the previous embodiments, they are provided in a matrix form, which may be rectangular, triangular, or hexagonal.

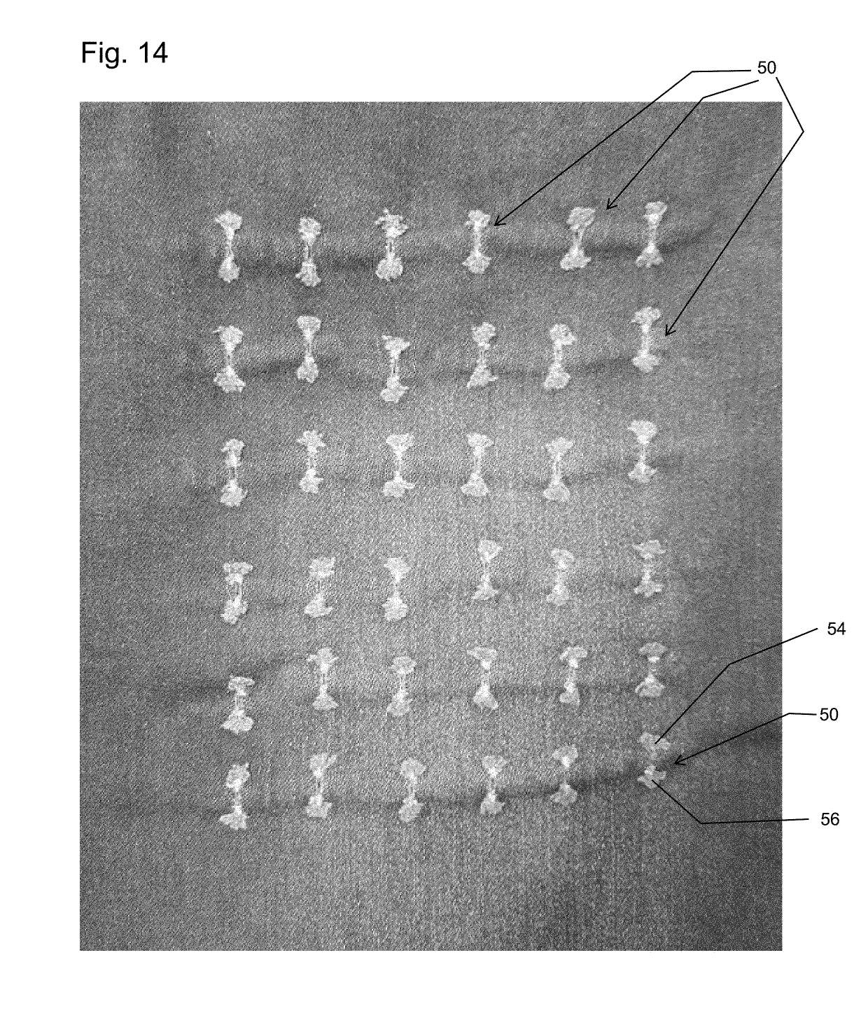

FIG. 14 is another top plan view showing holes (50) with vertical slit portions (visible in some of those, and provided just like in FIG. 12) and top and bottom end portions (54, 56) according to another embodiment of the invention. The top and bottom end portions (54, 56) may be formed by cut warps (W), which is shown in FIG. 13.

While the invention has been shown and described with reference to different embodiments thereof, it will be appreciated by those skilled in the art that variations in form, detail, compositions and operation may be made without departing from the spirit and scope of the invention.

What is claimed is:

1. A matrix for letters and patterns on fabric, the matrix comprising:
a plurality of holes, each of which being provided through the fabric, disposed in a matrix form;
a plurality of edge portions, each of which being installed at a corresponding one of the plurality of holes; and
one or more decorating portions, each of which being detachably attached to one of the plurality of edge portions.

2. The matrix of claim 1, wherein the matrix form for the plurality of holes includes a rectangular lattice structure.

3. The matrix of claim 1, wherein each of the plurality of edge portions comprises an eyelet, which is made of metal.

4. The matrix of claim 1, wherein each of the one or more decorating portions comprises a string configured to be queued through some of the plurality of edge portions, so as to make letters or patterns.

5. A matrix for letters and patterns on fabric, the matrix comprising:
a plurality of anchoring portions, each of which being provided on the fabric, disposed in a matrix form; and
one or more decorating portions, each of which being detachably attached to one of the plurality of anchoring portions.

6. The matrix of claim 5, wherein the matrix form for the plurality of anchoring portions includes a rectangular lattice structure.

7. The matrix of claim 5, wherein each of the one or more decorating portions comprises an engaging portion configured to be attached detachably to a corresponding anchoring portion, so as to attach the decorating portion to the corresponding anchoring portion.

8. The matrix of claim 5, wherein each of the plurality of anchoring portions comprises a thumbtack protruding upward or a thumbtack receding inward.

9. The matrix of claim 8, wherein each of the plurality of anchoring portions further comprises an edge portion, which is configured to be fixed to the fabric.

10. The matrix of claim 5, wherein each of the plurality of anchoring portions comprises a dumbbell-shaped hook having a top disk, a bottom disk, and a connecting cylinder connecting the top and bottom disks.

11. The matrix of claim 10, wherein the bottom disk is configured to be fixed to a rear side of the fabric and the connecting cylinder is disposed through the fabric

12. The matrix of claim 5, wherein each of the plurality of anchoring portions comprises an open hook having a hook portion and an engaging portion.

13. A matrix for letters and patterns on fabric, the matrix comprising a plurality of holes, each of which being provided through the fabric, disposed in a matrix form,
wherein each of the plurality of holes comprises:
a vertical slit portion;
a top end portion of warps forming the top edge of the vertical slit portion; and
a bottom end portion of warps forming the bottom edge of the vertical slit portion.

14. The matrix of claim 13, wherein the matrix form for the plurality of holes includes a rectangular lattice structure.

15. The matrix of claim 13, further comprising two side dot portions disposed on both sides of each of the vertical slit portions.

16. The matrix of claim 15, wherein the two side dot portions have a color different from colors of the fabric, or the top and bottom end portions of warps.
